(19) United States
(12) Patent Application Publication
(10) Pub. No.: US 2026/0324681 A1
(43) Pub. Date: Oct. 22, 2026

(54) MEAT-ANALOGUE COMPOSITION

(71) Applicant: AAK AB (PUBL), Malmö (SE)

(72) Inventors: Rodrigo MIYAKE, Malmö (SE); Lucas HARDY, Malmö (SE); Bruno MORAES, Malmö (SE); Suelen PELICIARI, Malmö (SE); Fidelmar BUCIO GARCIA, Malmö (SE)

(21) Appl. No.: 19/108,815

(22) PCT Filed: Sep. 13, 2023
(86) PCT No.: PCT/SE2023/050895

§ 371 Date: Mar. 5, 2025

(30) Foreign Application Priority Data
Sep. 13, 2022 (SE) 2230285-5

(51) Int. Cl. A23J 3/22; A23D 7/005

(52) U.S. Cl. CPC A23J 3/227; A23D 7/0053

(57) ABSTRACT

A meat analogue composition comprises from 2% to 23% by weight of a fat composition; from 5% to 30% by weight of a non-animal protein; and from 30% to 70% by weight of water; wherein the fat composition comprises from 10% to 40% by weight of palmitic acid (C16:0); from 1% to 15% by weight of stearic acid (C18:0); and from 35% to 70% by weight of oleic acid (C18:1); wherein said percentages of fatty acid residues refers to fatty acids bound as acyl groups in glycerides in the fat composition and being based on the total weight of C4 to C24 fatty acid residues bound as acyl groups present in the fat composition; and wherein the fat composition (i) has a saturated fatty acid content of from 25% to 50% by weight; (ii) comprises greater than 1.5% by weight of S3 triglycerides, wherein S refers to a saturated C14 to C20 fatty acid moiety present in the triglyceride molecule; and (iii) comprises less than 34% by weight of SUS triglycerides, wherein S refers to a saturated C14 to C20 fatty acid moiety and wherein U refers to a C14 to C20 unsaturated fatty acid moiety present in the triglyceride molecule; wherein said percentages of triglycerides refers to percentage by weight of glycerides present in the fat composition.

### FIELD OF THE INVENTION

The invention relates to meat analogue compositions comprising a fat composition, non-animal protein and water, the use of said meat analogue compositions in food products, and processes for making food products containing meat analogue compositions.

### BACKGROUND OF THE INVENTION

There is an increasing demand for plant-based foods due to consumer's increasing desire to eat healthy, sustainably sourced food products and to generally lower their meat intake.

This has led to the development of meat-analogues; meat-free, vegetarian or vegan food products which mimic certain qualities of meat or meat-based products, such as the texture, taste and/or appearance.

Many different types of meat-analogues are available, such as those based on tofu, lentils and beans, some of which aim to mimic meat completely in terms of sizzling and browning during cooking, bleeding, colour, texture and taste. One example of such meat-analogues is plant-based burgers. Products such as plant-based sausages, meat balls, meat loaf and nuggets are also known in the art.

The typical composition of known meat-analogues is 50 to 60% water, 10 to 25% proteins (such as soy, pea, potato and wheat), 5 to 23% fat, 0 to 10% carbohydrates, as well as flavourings and colourings. Various fats have been proposed for use in meat analogue compositions. It is important that the fat is not an animal-derived fat such that the meat analogue composition is suitable for consumption by vegetarians and vegans.

Accordingly, animal fats that are typically solid at room temperature are generally not used in meat analogue compositions.

In order to produce a desirable meat-analogue, it is important that the final meat analogue product have an appealing taste, texture and mouthfeel, and have similar taste, texture and mouthfeel to meat. Such properties are generally affected by the nature of the fat included in the meat analogue composition. The nature of the fat in meat analogue compositions also typically has an effect upon juiciness and flavour release of the compositions as the fats often function as carriers for fat soluble flavours. The nature of the fat is also important for the processability of the meat analogue dough such as during moulding of a meat analogue composition into burger patties, as discussed in further detail below. The nature of the fat is also important for providing visual similarity to meat products. Coconut oil, palm oil, sunflower oil and rapeseed oil are examples of vegetable derived fats that have been proposed for use in meat analogue compositions. It is desirable that the fats have a relatively high melting point in order to mimic effects such as the taste, texture and mouthfeel of high melting point animal fats found in meats which are typically solid at room temperature. As a result, coconut oil and palm oil have attracted attention as they have relatively high melting points compared to other vegetable oils.

Meat analogue compositions are typically prepared by mixing the fat with the other ingredients of the compositions such as the protein, water and other miscellaneous ingredients. Once this has occurred, the mixture is typically cooled down to low temperatures (generally −5° C. to 5° C. with −1° C. being typical) before processing such as molding into the particular type of meat analogue product such as burgers.

Where fats that are solid at room temperature such as palm oil or coconut oil are used, due to the difficulty of mixing hard solid fat, either a long mix time is required in order to effectively uniformly mix the fat with the other ingredients which increases the costs and inefficiency of the process; or, the fat is less well mixed into the meat analogue composition meaning that the meat analogue compositions have an undesirable non-homogenous fat distribution therein. One way of alleviating this issue is to heat the solid fat such as coconut oil or palm oil such that it melts prior to mixing with the other ingredients of the meat analogue composition. Typically, temperatures of 40° C. or greater are used to sufficiently melt the fat. The melted fats can then be mixed uniformly with the other ingredients of the composition more easily. However, a disadvantage of heating the fat prior to mixing is that the energy efficiency is reduced and the cost of the process is increased. Energy is required to heat and melt the fat. Additionally, the addition of heated melted fat to the other ingredients of the composition causes the temperature of the mixture to increase. More energy is then required to reduce the temperature of the mixture down to near −1° C. which is required for the further processing steps of molding the composition into burgers and other meat analogue products. Direct cooling by injecting a cold gas such as carbon dioxide or nitrogen into the mixture is typically used to reduce its temperature. Alternatively, vessels surrounded by a cooling jacket can be used to reduce the temperature of the meat analogue composition prior to molding and processing. Both of these cooling techniques require energy and more energy is expended if the initial temperature of the mixture is hotter.

An alternative strategy is to use oils that are liquid at room temperature such as sunflower oil or rapeseed oil. Such oils are easy to uniformly mix with the other ingredients of the meat analogue composition and do not require heating prior to admixture. However, a disadvantage with the use of such liquid oils is that the sensory properties of the meat analogue composition are compromised due to the liquid nature of the oils. Properties such as juiciness are compromised since the oil may seep out of the product during preparation. The liquid nature of the oils also means that there is no structuring potential of the meat analogue composition resulting in oily meat doughs. Oil loss during product preparation can also create problems during the moulding and processing of the meat analogue compositions. As a result, coconut oil and palm oil remain the industry standard for the fat used in meat analogue compositions.

### SUMMARY OF THE INVENTION

Appreciating the above problems associated with the use of palm oil and coconut oil in meat analogue compositions, the inventors of the present invention have surprisingly found that certain fats can easily be mixed uniformly with the other ingredients of the meat analogue compositions. Such fats have been found to have a lower yield value than coconut oil and palm oil at room temperature (20° C.) meaning that they can be easily and efficiently mixed with the other ingredients of the meat analogue composition at room temperature. The fats have been found as easy as other liquid oils such as sunflower oil to uniformly admix into the meat analogue compositions. The use of said fats thus provides the unexpected advantages over coconut oil and palm oil of considerably improved processability since energy is not required to melt the fats prior to mixture; and considerably less energy is required to cool the mixture down to −1° C. for further processing and molding of the compositions. In addition to the advantages discussed above, it has also surprisingly been found that the said fats also have a high crystallization speed that is faster than coconut oil and comparative to palm oil. The fast crystallization speed means that when the meat analogue compositions are cooled down for further processing and forming into meat analogue food products, the triglyceride molecules in the fat are readily crystallized forming solid fat crystals in the meat analogue compositions and provide structuring potential in the food products. The fats also have melting profiles that are comparative to other room temperature solid fats such as coconut oil and can thus be used in a similar way to provide desirable sensory properties to the meat analogue compositions.

The faster crystallization speed and greater solid fat content on cooling also provides various advantages over the use of low melting point liquid oils such as sunflower oil. As discussed above, often, liquid oils are lost from the meat analogue compositions upon processing. It has been found that the certain fat compositions used in the invention are lost less from the meat analogue compositions during processing in comparison to low melting point liquid oils. This is because the higher solid fat content of the fats when cooled means that the fats better handle heat generated from friction generated during the moulding process of forming shaped meat analogue food products. The certain fat compositions thus lose less fat due to melting by heat generated from friction when compared to liquid oils.

The certain fats have thus been surprisingly found to solve the problem of providing improved processability over palm oil and coconut oil without compromise of the sensory properties of the meat analogue compositions. As an additional advantage, the certain fat compositions have a lower saturated fat content than palm oil and coconut oil and so are healthier fats for consumers per unit weight.

According to a first aspect of the invention, there is provided a meat analogue composition comprising from 2% to 23% by weight of a fat composition; from 5% to 30% by weight of a non-animal protein; and from 30% to 70% by weight of water; wherein the fat composition comprises from 10% to 40% by weight of palmitic acid (C16:0); from 1% to 15% by weight of stearic acid (C18:0); and from 35% to 70% by weight of oleic acid (C18:1); wherein said percentages of fatty acid residues refers to fatty acids bound as acyl groups in glycerides in the fat composition and being based on the total weight of C4 to C24 fatty acid residues bound as acyl groups present in the fat composition; and wherein the fat composition (i) has a saturated fatty acid content of from 25% to 50%; (ii) comprises greater the 1.5% by weight of S₃ triglycerides, wherein S refers to a saturated C14 to C20 fatty acid moiety present in the triglyceride molecule; and (iii) comprises less than 34% by weight of SUS triglycerides, wherein S refers to a saturated C14 to C20 fatty acid moiety and wherein U refers to a C14 to C20 unsaturated fatty acid moiety present in the triglyceride molecule; wherein said percentages of triglycerides refers to percentage by weight of glycerides present in the fat composition.

It has been found that a certain balance of features of the fat compositions for use in the invention are important for achieving the advantages discussed above. There is a balance to be met between improving the processability of the fat composition by decreasing its yield value whilst also providing a composition with a fast enough induction time and crystallization speed. It has been found by the inventors that key properties of the fat composition are its saturated fat content; the amount of S₃ triglycerides present in the composition; the amount of SUS triglycerides present in the composition; and often the amount of symmetric triglycerides present in the fat composition.

Specifically, it has been found that if the composition has too high a saturated fat content, the yield value of the composition is too high and the composition is too hard to mix uniformly with ease with the other components of the meat analogue composition. On the other hand, if the saturated fat content of the composition is too low, it has been found that the composition is too hard to crystallise (i.e. has too high a crystallisation time) meaning that the fat composition has associated therewith the disadvantages discussed above associated with the use of room temperature liquid oils like sunflower oil.

The fat composition for use in meat analogue compositions of the invention comprises from 25% to 50% by weight of saturated fatty acids. Preferably, the fat compositions comprise from 33% to 48% by weight of saturated fatty acids. More preferably, the fat compositions comprise from 41% to 46% by weight of saturated fatty acids.

The fat compositions for use in the invention typically have a monounsaturated fatty acid content of from 35% to 70% by weight; preferably from 38% to 58% by weight; and more preferably from 41% to 46% by weight.

The fat compositions for use in the invention typically have a polyunsaturated fatty acid content of from 4% to 15% by weight; preferably from 7% to 15% by weight; and more preferably from 11% to 14% by weight.

Said percentages of fatty acid residues refers to fatty acids bound as acyl groups in glycerides in the fat composition and being based on the total weight of C4 to C24 fatty acid residues bound as acyl groups present in the fat composition.

The amount of SUS triglycerides present in the composition has also been found by the inventors to be important for achieving the balance of good processability and low yield value with a fast enough crystallization time. The compositions of the invention comprise less than 34% by weight of SUS triglycerides. Preferably, the compositions comprise from 18% to 34% by weight of SUS triglycerides; more preferably from 20% to 30% by weight of SUS triglycerides; and most preferably wherein the fat composition comprises from 22% to 28% by weight of SUS triglycerides. Additionally, it has typically been found that the ratio of SUS triglycerides to SUU triglycerides present in the composition aids in achieving the balance of properties discussed above. Typically, the fat composition comprises a weight ratio of SUS triglycerides to SUU triglycerides of from 0.35 to 0.90. Preferably, the fat composition comprises a weight ratio of SUS triglycerides to SUU triglycerides of from 0.35 to 0.70. More preferably, the fat composition comprises a weight ratio of SUS triglycerides to SUU triglycerides of from 0.35 to 0.60. Most preferably, the fat composition comprises a weight ratio of SUS triglycerides to SUU triglycerides of from 0.40 to 0.60.

The compositions of the invention are distinguished over RBD palm oil as RBD palm oil has a higher quantity of SUS triglycerides (and typically other symmetrical triglycerides as discussed below) present therein, which are believed by the inventors to provide the much higher yield values for palm oil and the difficulty in successfully mixing palm oil with the other components of the meat analogue composition. The compositions of the invention comprise an amount of SUS triglycerides more typically found in various palm olein fractions rather than RBD palm oil which is believed by the inventors to provide the lower yield values for the composition and improved processability.

The compositions of the invention comprise greater than 1.5% by weight S₃ triglycerides. Typically, the compositions comprise from 1.5% to 8% by weight of S₃ triglycerides. Preferably, the compositions comprise from 3% to 8% by weight of S₃ triglycerides, and more preferably from 3% to 5% by weight of S₃ triglycerides. The amount of S₃ triglycerides present in the composition has been found by the inventors to be important for achieving the preferable balance of properties discussed above. If the amount of S₃ triglycerides present in the composition is too low, the compositions will have a low yield value and sufficient processability. However, the compositions will have too slow a crystallization speed.

The amount of S₃ triglycerides present in fat compositions for use in the invention is more similar to that of RBD palm oil. The fat compositions for use in the invention are distinguished over palm olein fractions by their higher S₃ triglyceride content. Without being limited by theory, it is believed that the S₃ triglycerides present in the fat compositions act as seed crystals for crystallisation of the other triglycerides present in the fat compositions (such as the SUS and SUU triglycerides). This process of S₃ triglyceride seed crystallization is believed to be associated with the faster crystallization speed and higher solid fat contents of the fat compositions of the invention than other liquid oils such as sunflower oil and oils with comparative SUS triglyceride content (such as certain palm oleins).

It has been found that the triglyceride PPP is particularly good at providing this seed crystallization effect. PPP has been found to be better at providing this functionality than other S₃ triglycerides. A high PPP content as the S₃ triglyceride is thus particularly preferred. Typically, the fat composition comprises the triglyceride PPP in an amount greater than 1% by weight. Preferably, the fat composition comprises the triglyceride PPP in an amount greater than 1.25% by weight. More preferably, the fat composition comprises the triglyceride PPP in an amount of from 1.25% to 7.5% by weight. Most preferably, the fat composition comprises the triglyceride PPP in an amount of from 2.0% to 7.5% by weight. The triglyceride PPP is a triglyceride comprising three palmitic acid moieties.

In general, the amount of symmetric triglycerides present in the fat composition has also been found to contribute to achieving the balance of improved processability whilst still having a sufficiently fast crystallization speed. A symmetric triglyceride is one typically represented by the formulae SUS, SSS, UUU or USU, wherein U and S are as defined above. Examples of symmetric triglycerides include POP, PPP, OOO and SOS, where P is a palmitic acid residue; S is a stearic acid residue; and O is an oleic acid residue. An asymmetric triglyceride is one typically represented by the formulae SSU or SUU, wherein S and U are as defined above. It has been found that if the amount of symmetric triglycerides is too high, then the fat composition generally has too high a yield value and the improved processability and ease of mixing is not provided. In contrast, if the amount of symmetric triglycerides is too low, then the fat composition generally does not have a fast enough crystallization speed and high enough amount of solid fat at room temperature.

The more commonly occurring symmetric triglycerides in the fat compositions for use in the invention are POP, PPP, OOO and SOS, although other symmetric triglycerides may of course be present. Typically, the fat composition comprises the triglycerides POP, PPP, OOO and SOS in a total amount of from 22% to 34% by weight. Preferably, the fat composition comprises the triglycerides POP, PPP, OOO and SOS in a total amount of from 25% to 31% by weight. More preferably, the fat composition comprises the triglycerides POP, PPP, OOO and SOS in a total amount of from 25% to 28% by weight.

Typically, the fat compositions for use in the invention comprise the triglycerides POP, PPP, POO, OOO, PLO, PLP, MOO and PLL, although it will be understood that it is not essential that the fat compositions comprise each of these triglycerides. The fat compositions for use in the invention also typically comprise smaller amounts of the triglycerides PSS, SOS, PPS, POS, SOO and PLS, although it will be understood that it is not essential that the fat compositions comprise each or even any of these triglycerides.

The letter P is used to denote a palmitic acid moiety; the letter S is used to denote a stearic acid moiety; the letter O is used to denote an oleic acid moiety; the letter L is used to denote a linoleic acid moiety; and the letter M is used to denote a myristic acid moiety.

Typically, the fat composition comprises the triglyceride POP in an amount less than 25% by weight; preferably less than 20% by weight; and more preferably in an amount of from 14% to 20% by weight.

Typically, wherein the fat composition comprises the triglycerides PLP and MOO in a combined amount of 8% or less by weight; preferably a combined amount of from 4% to 8% by weight; and more preferably a combined amount of from 4% to 7% by weight.

Typically, the fat composition comprises the triglyceride POO in an amount of from 15% to 35% by weight; preferably 22% to 32% by weight; and more preferably 25% to 30% by weight.

Typically, the fat composition comprises the triglyceride OOO in an amount of from 2% to 10% by weight; preferably 4% to 10% by weight; and more preferably 4% to 8% by weight.

Typically, the fat composition comprises the triglyceride PLO in an amount of from 7.5% to 17.5% by weight; and preferably 10% to 14% by weight.

Typically, the fat composition comprises the triglyceride PLL in an amount of from 2% to 6% by weight.

Typically, the fat composition comprises any one or more of:
(a) from 1% to 3% of a combined amount of the triglycerides MOP and PPP;
(b) from 2% to 6% of the triglyceride PLL;
(c) from 0.5% to 2% of the triglyceride PLS;
(d) less than 5% of the triglyceride SOO;
(e) less than 5% of the triglyceride POS;
(f) less than 5% of the triglyceride PPS;
(g) less than 1% of the triglyceride SOS; and
(h) less than 1% of the triglyceride PSS

Preferably, the fat composition comprises all of features (a) to (h). The abbreviation Po is used to denote a palmitoleic acid residue.

Typically, the fat composition comprises from 4% to 15% by weight linoleic acid (C18:2).

Typically, the fat composition comprises one or more of the following features:
(i) from 20% to 40%, preferably from 30% to 38% by weight palmitic acid (C16:0);
(ii) from 2% to 11%, preferably from 3% to 6% by weight stearic acid (C18:0);
(iii) from 38% to 58%, preferably from 41% to 46% by weight oleic acid (C18:1); and
(iv) from 7% to 15%, preferably 10% to 14% by weight linoleic acid (C18:2).

Preferably, the fat composition comprises all of features (i) to (iv).

The fat compositions for use in the meat analogue compositions of the invention are distinguished from coconut oil in that they have a lower saturated fatty acid content than coconut oil and a higher unsaturated fatty acid content. For example, coconut oil has a lower oleic acid and linoleic acid content than the ranges specified above. Coconut oil also has a lower palmitic acid content than the ranges specified above. Coconut oil contains a high amount of the saturated fatty acid lauric acid which contributes to its high saturated fatty acid content.

Typically, the fat composition has one or more of the following features:
(i) a solid fat content at 10° C. of from 16 to 55; preferably from 23 to 44; and more preferably from 30 to 37;
(ii) a solid fat content at 20° C. of from 6 to 33; preferably from 8 to 25; and more preferably from 10 to 17;
(iii) a solid fat content at 25° C. of from 1 to 24; preferably from 3 to 17; more preferably from 4 to 10; and
(iv) a solid fat content at 30° C. of at most 17; preferably at most 12; and more preferably at most 6.

Preferably, the fat composition comprises all of features (i) to (iv).

It is preferable that the fat composition comprises a solid fat content within the above ranges. Lower solid fat contents will typically mean that the fat is not solid enough to have structuring potential and provide the desired sensory properties for the meat analogue composition. In contrast, if the solid fat content is higher than the above ranges, typically, the fat will be too hard at room temperature and have the processing problems discussed above associated with coconut oil and palm oil.

The fat composition may be made from naturally occurring or synthetic fats, fractions of naturally occurring or synthetic fats, or mixtures thereof, that satisfy the requirements for fatty acids and triglyceride compositions discussed above. Preferably, the fat composition is derived from a blend of naturally occurring fats.

The fat compositions for use in meat analogue compositions of the invention are preferably derived from non-animal sources. Any suitable non-animal derived fat source can be used as a component of the fat compositions of the invention, provided that the fat composition fulfils the criteria specified above.

Typically, the fat compositions for use in the meat analogue compositions of the invention comprise a palm olein, an interesterified palm olein, or a combination thereof. More typically, the fat compositions for use in the invention comprise an interesterified palm olein, a blend of an interesterified palm olein and a palm olein, or a blend of palm olein and palm oil.

Preferably, the fat composition comprises (i) an interesterified palm olein with an iodine number of from 54 to 58; (ii) a blend of an interesterified palm olein with an iodine number of from 54 to 58 and a palm olein with an iodine number of from 60 to 64; or (iii) a blend of a palm olein with an iodine number of from 60 to 64 and palm oil.

More preferably, the fat composition comprises a blend of from 40% to 60% by weight palm oil and from 40% to 60% by weight palm olein with an iodine number of from 60 to 64; or (b) the fat composition comprises a blend of an interesterified palm olein with an iodine number of from 54 to 58 in an amount of from 20% to 80% by weight and a palm olein with an iodine number of from 60 to 64 in an amount of from 20% to 80% by weight.

Most preferably, the fat composition comprises interesterified palm olein with an iodine number of from 54 to 58 present in an amount of from 40% to 60% by weight and palm olein with an iodine number of from 60 to 64 present in an amount of from 40% to 60% by weight.

In the instances described in the paragraphs above, preferably, (a) the interesterified palm olein with an iodine number of from 54 to 58 is interesterified palm olein with an iodine number of 56; and/or (b) the palm olein with an iodine number of from 60 to 64 is palm olein with an iodine number of 62.

The term “fat” as used herein refers to glyceride fats and oils containing fatty acid acyl groups and does not imply any particular melting point. The term “oil” is used synonymously with “fat” herein.

The term “fatty acid”, as used herein, refers to straight chain saturated or unsaturated (including mono- and poly unsaturated) carboxylic acids having 8 to 24 carbon atoms. A fatty acid having x carbon atoms and y double bonds may be denoted Cx:y. For example, palmitic acid may denoted C16:0, oleic acid may denoted C18:1. Percentages of fatty acids in compositions referred to herein include acyl groups in tri-, di- and mono-glycerides present in the glycerides and are based on the total weight of C8 to C24 fatty acids. The fatty acid profile (i.e. composition) may be determined, for example, by fatty acid methyl ester analysis (FAME) using gas chromatography according to ISO 12966-2 and ISO 12966.4.

Triglyceride content may be determined for example based on molecular weight differences (Carbon Number (CN)) by AOCS Ce 5-86. The notation triglyceride CNxx denotes triglycerides having xx carbon atoms in the fatty acyl groups, e.g. CN54 includes tristearin. Amounts of triglycerides specified with each carbon number (CN) as is customary terminology in the art are percentages by weight based on total triglycerides of CN26 to CN62 present in the fat composition.

As discussed above, preferably, the fat compositions of the invention comprise an interesterified fat. The interesterified fat may be produced by chemical interesterification, enzymatic interesterification, or a combination thereof.

Processes for the preparation of interesterified fats are known in the art, and are discussed in, for example, Dijkstra, A. J. Interesterification. In: The Lipids Handbook 3^{rd} Edition, pages 285-300 (F. D. Gunstone, J. L. Harwood, and A. J. Dijkstra (eds.), Taylor & Francis Group LLC, Boca Raton, FL) (2007).

Preferably, the fat composition contains a substantially major portion of fat with very little water (i.e. the fat composition consists essentially of fat molecules). However, in some embodiments, the fat composition may contain water and be present in the form of an emulsion such as an oil-in-water emulsion or a water-in-oil emulsion, typically with a suitable emulsifier. In such embodiments, the weight percentage ranges provided above for the amount that the fat composition is present in the meat analogue composition refers to only fat molecules present in the fat composition, and not any water present in the composition. Similarly, the weight percentages given above for the amount of water present in the meat analogue composition refers to both water added in its own right during manufacture of the meat analogue composition, and also to any water present in other components of the meat analogue composition (such as water present in an emulsified fat composition), or water bound to any protein, as discussed in further detail below.

The meat compositions of the invention comprise one or more non-animal proteins, such as one or more proteins derived from fungi, plants, or a combination thereof.

Typically, the non-animal protein comprises plant protein. Preferably, the plant protein is selected from algae protein, black bean protein, canola wheat protein, chickpea protein, fava protein, lentil protein, lupin bean protein, mung bean protein, oat protein, pea protein, potato protein, rice protein, soy protein, sunflower seed protein, wheat protein, white bean protein, and protein isolates or concentrates thereof. In other embodiments, the non-animal protein comprises seitan, rice protein, mushroom protein, legume protein, tempeh, yam flour, tofu, mycoprotein, peanut flour, yuba, or a combination thereof.

More preferably, the non-animal protein comprises texturized vegetable proteins, preferably wherein the texturized vegetable proteins comprise texturized pea proteins, texturized fava proteins, texturized soy proteins, texturized wheat proteins or a combination thereof. Preferably, the texturized vegetable protein is present in the meat analogue composition in an amount of from 10% to 20% by weight of the meat analogue composition.

The non-animal protein is present in the meat analogue composition in an amount of from 5% to 30% by weight of the meat analogue composition. Preferably, the non-animal protein is present in the meat analogue composition in an amount of from 10% to 30% by weight of the meat analogue composition, and more preferably from 15% to 30% by weight of the meat analogue composition.

Plant protein is a source of protein which is obtained or derived from plants. The plant protein may be any suitable plant protein and may comprise a mixture of plant proteins and/or may include protein isolates or concentrates. Examples of suitable plant proteins include those discussed above. As discussed above, preferably, the plant protein comprises textured vegetable proteins (TVP). TVPs are extruded proteins, which may be either dry or moist (i.e. hydrated). TVP is widely available and may be made from plant sources as mentioned above, such as soy flour or concentrate. In dry form, TVP can comprise up to about 70 wt. % of protein, typically about 60 to 70 wt. % of protein, and when hydrated comprises typically about 10 to 20 wt. % of protein. Typically, when hydrated TVPs can contain up to 3 to 4 times their dry weight in water. As discussed above, the weight percentage ranges referred to above for water present in the meat analogue compositions include both water added in its own right and water present in other components of the meat analogue composition such as in textured vegetable proteins or emulsified with fat. Similarly, the weight percentage ranges given above for the amount of non-animal protein present in the meat analogue composition refer to dry weight of protein, and do not include water bound to the non-animal protein such as in textured vegetable protein.

The plant protein used in the preparation of the meat-analogue composition may be either dry (also referred to as ‘dry phase’ herein) or moist. Thus, in embodiments, the plant protein may be included in a dry mix of ingredients, which may include additional ingredients intended for inclusion in the meat-analogue composition, such as carbohydrates, fibre and/or hydrocolloids, in addition to protein. If the plant protein is dry, it may be hydrated prior to and/or during the formation of the meat-analogue composition.

The term ‘dry’ used in relation to the plant protein and ‘dry phase’ used herein, is intended to mean that the phase comprising plant protein comprises less than 5 wt. % water, preferably less than 2 wt. % water, more preferably less than 1 wt. % water, even more preferably that it is substantially free from water. In other preferred embodiments, the a, of the dry phase is 0.90 or lower, more preferably below 0.80. The dry phase comprising plant protein is typically provided in a substantially dehydrated state to reduce microbial growth as far as possible so as to extend shelf life.

The meat-analogue composition comprises water, which may be added as a separate component to the composition, or derive from other components of the composition as discussed above. The amount of water is not particularly limited and, as the skilled person will appreciate, will vary depending on the intended consistency of the meat-analogue composition. Reference to ‘water’ herein is intended to include drinking water, demineralized water or distilled water, unless specifically indicated. Preferably, the water employed in connection with the present invention is demineralised or distilled water. As the skilled person will appreciate, deionized water is also a sub-class of demineralized water.

The meat analogue composition typically comprises one or more additional ingredients.

Whilst these one or more additional ingredients may be preferable to include in the meat analogue compositions, it will be understood that the inclusion of the one or more additional ingredients is not essential.

The meat analogue composition preferably further comprises a stabilizer blend.

Preferably, the stabilizer blend is present in the meat analogue composition in an amount of from 5% to 10% by weight of the meat analogue composition. Typically, the stabilizer blend comprises vegetable derived protein, vegetable fibre and/or a polysaccharide.

Preferably, the vegetable derived protein comprises pea protein, the vegetable fibre comprises pea fibre, and/or the polysaccharide comprises methylcellulose. In highly preferred embodiments, the stabiliser blend comprises vegetable derived protein comprising pea protein, vegetable fibre comprising pea fibre, and polysaccharide comprising methylcellulose.

The meat analogue composition may comprise one or more flavouring additives.

Preferably, the one or more flavouring additives are present in an amount of from 0.5% to 2% by weight of the meat analogue composition. Suitable flavouring additives known in the art may be used in the meat analogue compositions.

The meat analogue composition may comprise one or more colouring additives. Typically, the one or more colouring additives are present in an amount of from 0.5% to 5% by weight of the meat analogue composition. Suitable colouring additives known in the art may be used in the meat analogue compositions.

In some embodiments, the meat analogue composition further comprises one or more of: i) polysaccharides and/or modified polysaccharides, preferably selected from methylcellulose, hydroxypropyl methylcellulose, carboxymethyl cellulose, maltodextrin, carrageenan and salts thereof, alginic acid and salts thereof, agar, agarose, agaropectin, pectin and alginate; ii) hydrocolloids; and iii) gums, preferably selected from xanthan gum, guar gum, locust bean gum, gellan gum, gum arabic, vegetable gum, tara gum, tragacanth gum, konjac gum, fenugreek gum, and gum karaya.

Examples of other additives that may be included in the meat analogue compositions include an ionic or non-ionic emulsifier, a polyhydroxy compound, milk, liquid flavours, alcohols, humectants, honey, liquid preservatives, liquid sweeteners, liquid oxidising agents, liquid reducing agents, liquid anti-oxidants, liquid acidity regulators, liquid enzymes, milk powder, hydrolysed protein isolates (peptides), amino acids, yeast, sugar substitutes, starch, salt, spices, fibre, flavour components, colourants, thickening and gelling agents, egg powder, enzymes, gluten, vitamins, preservatives, sweeteners, oxidising agents, reducing agents, anti-oxidants, acidity regulators, or combinations thereof.

Amino acids are a preferred additive for the meat-analogue compositions of the invention, since these are known to contribute to the Maillard reaction, a form of non-enzymatic browning resulting from the chemical reaction between amino acids and sugars upon heating. This is used in flavour development of cooked foods and this reaction can be used in the meat-analogue composition to replicate the taste of meat by creating savoury meaty flavours.

In preferable embodiments, the meat analogue is suitable for consumption by vegetarians and vegans. Accordingly, in preferable embodiments, the meat analogue composition is substantially free of animal protein, and more preferably, the meat analogue composition is free of animal protein.

In preferable embodiments, the meat analogue composition is substantially free of animal-derived products, and more preferably, the meat analogue composition is free of animal-derived products.

However, in some embodiments, the meat analogue compositions may comprise animal-derived products such as animal derived proteins or fats. Accordingly, in some embodiments, the meat analogue composition further comprises one or more animal-derived products such as animal oils, marine oils, animal-derived proteins, animal-derived polysaccharides, or any combination thereof. In some embodiments, the one or more animal-derived products comprise animal milk proteins, animal milk fats, or a combination thereof. In these embodiments, the meat analogue compositions may be suitable for consumption by vegetarians on the basis that they comprise non-animal protein and proteins or fats derived from animal milk. These meat analogue compositions are suitable for consumption by vegetarians since they do not include fats or proteins derived from meat. However, it will of course be understood that such meat analogue compositions are not suitable for consumption by vegans.

In embodiments where the meat analogue compositions comprise one or more animal-derived products, the one or more animal-derived products are typically present in the meat analogue composition in an amount of from 1% to 20% by weight of the meat analogue composition.

According to a second aspect of the invention, there is provided a food product comprising a meat analogue composition of the invention. The food product may be an uncooked food product, a cooked food product, or a partially cooked food product.

Typically, the food product is a vegetarian or vegan meat substitute food product.

Preferably, the vegetarian or vegan meat substitute food product is a burger, sausage, meat ball, nugget, patty, mince product, meatloaf, or other product intended to mimic conventional meat-based food products.

The properties of the meat-analogue composition or food products prepared using the composition may be measured by any suitable means. Properties of interest may include juiciness (and/or dryness), hardness, adhesiveness, springiness, cohesiveness, gumminess, chewiness and resilience. Such means include taste testers, which can provide feedback on properties of the composition or food product such as juiciness (or dryness), texture, chewiness and hardness. Typically multiple testers will be asked to mark one or more properties of the composition or food product, such as on a scale from 1 to 5. If multiple testers are asked, an average of the results can be taken to observe the general impression of the food product.

Properties of the composition or food product may also be measured using specialised equipment. For example, texture profile analysis (TPA) is a technique used to characterize textural attributes of solid and semisolid materials and may be used to determine the hardness, adhesiveness, springiness, cohesiveness, gumminess, chewiness and resilience. Gumminess is defined as the product of hardness x cohesiveness. Chewiness is defined as the product of gumminess x springiness (hardness x cohesiveness x springiness). In this technique, the test material may be compressed two times in a reciprocating motion, mimicking the chewing movement in the mouth, producing a Force versus Time (and/or distance) graph, from which the above information can be obtained.

TPA and the classification of textural characteristics is described further in Bourne M. C., Food Technol., 1978, 32 (7), 62-66 and Trinh T. and Glasgow S., ‘On the texture profile analysis test’, Conference Paper, Conference: Chemeca 2012, Wellington, New Zealand, and may be performed as described therein.

The Force versus Time (and/or distance) graph typically includes two peaks in force, corresponding to the two compressions, separated by a trough. Force may be measured in gravitational force equivalent (g-force, g) or Newtons (N).

Hardness (g or N) is defined as the maximum peak force experienced during the first compression cycle.

Adhesiveness is defined as the negative force area for the first bite, i.e. the area of the graph between the two peaks in force which is at or below a force of 0 g or N. This represents the work required to overcome the attractive forces between the surface of a food and the surface of other materials with which the food comes into contact, i.e. the total force necessary to pull the compression plunger away from the sample. For materials with a high adhesiveness and low cohesiveness, when tested, part of the sample is likely to adhere to the probe on the upward stroke. Lifting of the sample from the base of the testing platform should, if possible, be avoided as the weight of the sample on the probe would become part of the adhesiveness value. In certain cases, gluing of the sample to the base of a disposable platform has been advised but is not applicable for all samples.

Springiness, also known as elasticity, is related to the height that the food recovers during the time that elapses between the end of a first compression and the start of a second compression. During the first compression, the time from the beginning of the compression at force=0 g or N to the first peak in force is measured (referred to as ‘Cycle 1 Duration’). During the second cycle, the time from the beginning of the second compression at force=0 g or N to the second peak in force is measured (referred to as ‘Cycle 2 Duration’). Springiness is calculated as the ratio of these values, i.e. ‘Cycle 2 Duration’/‘Cycle 1 Duration’.

Cohesiveness is defined as the ratio of the positive force area, i.e. the area under the curve above a force of 0 g or N, during the second compression to that during the first compression. Cohesiveness may be measured as the rate at which the material disintegrates under mechanical action. Tensile strength is a manifestation of cohesiveness. If adhesiveness is low compared with cohesiveness then the probe is likely to remain clean as the product has the ability to hold together. Cohesiveness is usually tested in terms of the secondary parameters brittleness, chewiness and gumminess. Gumminess is defined as the product of hardness x cohesiveness and is a characteristic of semisolid foods with a low degree of hardness and a high degree of cohesiveness.

Chewiness is defined as the product of gumminess x springiness (which equals hardness×cohesiveness×springiness) and is therefore influenced by the change of any one of these parameters.

Resilience is a measurement of how the sample recovers from deformation both in terms of speed and forces derived. It is taken as the ratio of areas from the first probe reversal point, i.e. the point of maximum force, to the crossing of the x-axis, i.e. at 0 g or N, and the area produced from the first compression cycle between the start of compression and the point of maximum force. In order to obtain a meaningful value of this parameter, a relatively slow test speed should be selected that allows the sample to recover, if the sample possesses this property.

According to a third aspect of the invention, there is provided the use of a fat composition in a meat analogue composition, wherein the fat composition comprises from 10% to 40% by weight of palmitic acid (C16:0); from 1% to 15% by weight of stearic acid (C18:0); and from 35% to 70% by weight of oleic acid (C18:1); wherein said percentages of fatty acid residues refers to fatty acids bound as acyl groups in glycerides in the fat composition and being based on the total weight of C4 to C24 fatty acid residues bound as acyl groups present in the fat composition; and wherein the fat composition (i) has a saturated fatty acid content of from 25% to 50%; (ii) comprises greater the 1.5% by weight of S₃ triglycerides, wherein S refers to a saturated C15 to C20 fatty acid moiety present in the triglyceride molecule; and (iii) comprises less than 34% by weight of SUS triglycerides, wherein S refers to a saturated C15 to C20 fatty acid moiety and wherein U refers to a C15 to C20 unsaturated fatty acid moiety present in the triglyceride molecule; wherein said percentages of triglycerides refers to percentage by weight of glycerides present in the fat composition.

Preferably, the use further comprises using the meat analogue composition in a food product.

Preferably, the meat analogue composition, fat composition and/or food product are as described above.

Preferably, the use comprises using the fat composition to improve the nutritional profile of the meat analogue composition when compared to an analogous meat analogue composition comprising the same amount by weight of coconut oil. The use may comprise using the fat composition to improve the nutritional profile of the meat analogue composition when compared to an analogous meat analogue composition comprising the same amount by weight of coconut oil. The term analogous meat analogue composition as used herein is used to refer to an equivalent weight of a meat analogue composition that is identical to the meat composition of the invention, with the exception of the nature of the fat present therein. The analogous meat analogue composition contains the same amount by weight of coconut oil as the meat analogue composition of the invention contains the fat composition. The nutritional profile of the meat analogue composition of the invention may be improved in comparison to coconut oil since it contains a lower total amount of saturated fatty acid residues per unit weight than coconut oil. Coconut oil contains around 90% saturated fatty acid residues. Without being limited by theory, it is believed that fats with higher saturated fatty acid contents increase the risk of heart disease, high blood pressure and associated conditions, and also have a detrimental effect upon the cholesterol levels of consumers. Accordingly, in some embodiments, the use comprises using the fat composition to improve the effect on in vivo cholesterol levels in a consumer of the meat analogue composition when compared to an analogous meat analogue composition comprising the same amount by weight of coconut oil, although it will be appreciated that other health and wellbeing benefits may also be realised by the use of the fat compositions in meat analogue compositions in place of coconut oil and similar fats.

Preferably, the use comprises using the fat composition to provide improved processability to the meat analogue composition when compared to an analogous meat analogue composition comprising the same amount by weight of coconut oil, and/or an analogous meat analogue composition comprising the same amount by weight of palm oil, preferably wherein the improved processibility comprises a reduced energy requirement for manufacturing the meat analogue composition. The lower yield value for the fat compositions of the invention mean that the fats can be more easily mixed with the other ingredients of the meat analogue composition. This eliminates or reduces the need for the fat to be heated and melted prior to admixture with the other components. The need to expend energy to heat the fats is therefore reduced or minimised. Additionally, since the need to heat the fat is reduced or eliminated, the mixture of fat composition and other ingredients of the meat analogue composition is cooler after admixture meaning that less energy is required to subsequently cool the mixture down to temperatures of around −1° C. for the subsequent stage of molding the meat analogue composition into food products such as burgers. The energy requirements of the process are thus reduced. Additionally, the increased crystallization speed of the fats means that solid fat is crystallized quickly upon cooling down the fat for further processing, meaning that less oil is lost from the meat analogue composition during processing due to the lower liquid oil content.

According to a fourth aspect of the invention, there is provided a process of manufacturing a meat analogue composition according to the invention, or a food product according to the invention, wherein the process comprises:
(a) providing a mixture of water and non-animal protein;
(b) combining the mixture from step (a) with a fat composition as described herein and optionally one or more additional components to form the meat analogue composition; and
(c) optionally forming the meat analogue composition into food products.

Preferably, the process further comprises cooking the food product to form a cooked food product or partially cooked food product.

Preferably, the process further comprises mixing (i) the mixture of water and non-animal protein provided in step (a); (ii) a mixture formed in step (b) by combining the mixture from step (a) with the fat composition and optionally one or more additional components; and/or (iii) mixing the one or more additional components with water prior to combination of the one or more additional components with the mixture from step (a) and the fat composition.

Any suitable mixing process and apparatus known in the art may be used for the mixing steps discussed above.

Preferably, the fat composition is not melted prior to combining with the mixture from step (a) and optionally one or more additional components. As discussed above, this feature of the process is advantageous since the energy requirements of the process are reduced.

More preferably, the process further comprises mixing the mixture formed in step (b) by combining the mixture from step (a) with the fat composition and optionally one or more additional components. Typically, the mixing is carried out at a temperature of from 1° C. to 20° C.; preferably 1° C. to 18° C.; more preferably 1° C. to 15°; and most preferably from 10° C. to 15° C.

Typically, the process further comprises step (c) of forming the meat analogue composition into food products, and wherein after step (b) but prior to step (c), the process further comprises cooling the meat analogue composition to a temperature of from −5° C. to 5° C.; preferably from −2° C. to 2° C. Typically, the cooling comprises injecting a gas such as nitrogen or carbon dioxide into the meat analogue composition; or placing a cooling jacket around the meat analogue composition. Any suitable apparatus known in the art for cooling meat analogue compositions may be used and any suitable apparatuses and processes for forming the meat analogue composition into food products known in the art may be used.

Whilst the above-described steps are preferable steps for manufacturing the meat analogue compositions or food products described herein, it will be appreciated that other suitable processes may also be used to manufacture the meat analogue compositions and food products.

The meat-analogue composition of the present invention may be readily prepared by blending a fat composition as described herein with plant protein and any other components of the composition. In one embodiment, there is provided a process for preparing a meat-analogue composition, said process comprising the step of: forming the meat-analogue composition by blending a plant protein with a fat composition as described herein. Optionally, further ingredients may be present. Water may be added to the composition if required at any stage during the process. The process may further comprise the step of preparing the plant protein by providing a dry phase comprising plant protein and blending the dry phase with an amount of water, which precedes the step of forming the meat-analogue composition. This step may also include other ingredients which are in dry form, such that these dry ingredients are hydrated simultaneously with the plant protein. Additionally and/or alternatively, any other dry ingredients may be hydrated separately from the plant protein in any combination. In embodiments which include TVPs, the TVP is preferably hydrated separately from any other dry ingredients.

Without being bound by theory, this is believed to limit competition between the dry components for the water and ensure satisfactory hydration for all dry components present.

Thus, disclosed herein is a process for preparing a meat-analogue composition, said process comprising the steps of: a) providing a dry phase comprising plant protein and optionally any other dry ingredients of the composition and blending the dry phase with an amount of water to form a mixture; b) forming the meat-analogue composition by blending the mixture formed in step a) with a fat composition as described herein. In embodiments, the plant protein may comprise TVPs. Preferably, dry ingredients other than the plant protein are hydrated separately from the plant protein. Examples of such dry ingredients include, but are not limited to, fibres, flavours, emulsifiers, gums, hydrocolloids, thickeners.

In embodiments, the mixture of step a) comprising the hydrated plant protein and any other mixtures comprising hydrated dry ingredients are combined prior to step b). Without being bound by theory, it is believed that the hydration of dry ingredients prior to the addition of the fat composition (for example, in step a)) results in an optimal distribution of water in the product, resulting in a more stable meat-analogue composition.

The dry phase comprising plant protein used in the above process is not particularly limited. The plant protein is as described hereinabove. The term ‘dry phase’ is intended to mean that the phase comprising plant protein comprises less than 5 wt. % water, preferably less than 2 wt. % water, more preferably less than 1 wt. % water, even more preferably that it is substantially free from water. In other preferred embodiments, the a, of the dry phase is 0.90 or lower, more preferably below 0.80. The dry phase comprising plant protein is typically provided in a substantially dehydrated state to reduce microbial growth as far as possible so as to extend shelf life.

The dry phase, which may comprise plant protein, may take any physical form before being blended with water, however typically it is in powder, granule or pelletized, strip or chunk form. The amount of water added to the dry phase is not particularly limited.

Typically, an amount of water is added in order to bind the dry components into a paste or dough with which the fat composition may be readily blended. The amount of water added to the dry phase is preferably calculated such that the total amount of water in the meat-analogue composition after addition of the other components of the fat composition are within the ranges described above.

The temperature of the water added is not particularly limited, so long as it does not materially impact the intended characteristics of the components (e.g. does not lead to protein denaturation or hydrolysis). In preferred embodiments, the water is below room temperature (i.e. below 20° C.). In particularly preferred embodiments, ice water is used. This is particularly preferred when water is added to the dry phase. The term “ice water” is defined herein as having a temperature of above 0° C. and below 6° C., preferably from 0.5 to 5° C., more preferably from 1 to 4° C., more preferably from 1 to 3° C. An advantage of using ice water is that it slows microbial growth as far as possible during preparation of the meat-analogue composition and it is particularly suitable for the hydration of certain dry ingredients as methylcellulose.

The blending of the dry phase with water may be performed for any duration of time. In embodiments, blending is performed until the dry phase and water are intimately mixed and typically until a paste or dough is formed. In embodiments in which TVPs are hydrated, blending is limited to a minimum so as not to overly disturb the fibrous structures. In embodiments this may be performed for a duration of from 1 minute to 30 minutes, preferably from 1 minutes to 10 minutes, more preferably from 5 seconds to 5 minutes.

Following blending of the dry phase and water, for example in step a), the mixture may be allowed to rest prior to the addition of the fat composition, for example in step b). This may ensure full hydration of the dry phase prior to addition of the fat composition. This rest may be performed under cold storage (thereby further controlling microbial growth), which has a temperature of from 0.5 to 15° C., preferably from 1 to 12° C., more preferably from 5 to 10° C. This rest may be performed for a duration of from 5 minutes to 5 hours, preferably from 5 minutes to 2 hours, more preferably from 5 minutes to 30 minutes.

As discussed above, once the fat composition has been added to the other ingredients of the fat composition, the mixture is typically mixed or blended using suitable processes and apparatus known in the art.

Preparation of the meat-analogue composition may also comprise the step of adding further ingredients to the composition. These ingredients may be added at any stage in the preparation of the meat-analogue composition. In embodiments, further ingredients are added after the addition of the fat composition, for example after step b). Preferably, dry ingredients are hydrated prior to addition to the fat composition. In embodiments, dry ingredients are hydrated with any dry plant protein, such as in step a), prior to the addition of the fat composition. Such ingredients may include one or more of carbohydrates, polysaccharides, modified polysaccharides, hydrocolloids, gums, milk, liquid flavours, alcohols, humectants, honey, liquid preservatives, liquid sweeteners, liquid oxidising agents, liquid reducing agents, liquid anti-oxidants, liquid acidity regulators, liquid enzymes, milk powder, hydrolysed protein isolates (peptides), amino acids, yeast, sugar substitutes, starch, salt, spices, fibre, flavour components, colourants, thickening and gelling agents, egg powder, enzymes, gluten, vitamins, preservatives, sweeteners, oxidising agents, reducing agents, anti-oxidants, and acidity regulators, as disclosed in more detail herein. The addition of these ingredients may be performed by blending, mixing or any suitable means.

Once the meat-analogue composition has been prepared, this may be formed into a food product. This may include the step of forming the meat-analogue composition into the desired shape. The shape and size of the resulting food product is not particularly limited.

Examples of shaped food products which can be made from the meat-analogue composition according to the present invention include burgers, sausages, nuggets, meatballs and mince.

Any suitable method may be used to shape the meat-analogue composition into the desired shape. In embodiments, this may be performed by cutting, moulding, pressing, extrusion, rolling, grinding or any combination thereof. These processes may be performed using an apparatus, which may be operated manually or may be automated. In embodiments, the meat-analogue composition may be compressed for 5 minutes to 24 hours, preferably 1 hour to 12 hours, more preferably 3 hours to 8 hours. The duration and pressure of compression is determined by the desired properties of the resulting food product, such as its size and density, taking into account the properties of the meat-analogue composition, such as adhesiveness, among other factors. This may form the desired shape of the food product, or it may be further processed such as by pelletizing, grinding or cutting, for instance to replicate the attributes of ground/minced meat. As discussed above, typically, the step of shaping the meat analogue composition is carried out at cold temperatures of from −5° C. to 5° C.

The process of preparing a meat-analogue composition may further comprise cooking or part-cooking the composition, which may have been formed into a food product. Cooking may comprise boiling, baking, frying and/or microwaving. In preferred embodiments, cooking is at sufficient temperature such that the Maillard reaction may occur (for example, above 80° C. and up to 180° C., preferably from 130° C. to 170° C.). The Maillard reaction is useful for desirable browning of the food product.

### DESCRIPTION OF THE DRAWINGS

FIGS. 1 and 2 show the solid fat content percentage isotherms for various fat compositions for use in the present invention, coconut oil and palm oil.

FIG. 3 shows the solid fat content percentage isotherms for various fat compositions for use in the present invention.

FIGS. 4 and 5 show the triacylglyceride (TAG) compositions of various fat compositions for use in meat analogue compositions of the invention, and RBD palm oil.

### DETAILED DESCRIPTION OF THE INVENTION

The following examples are for illustrative purposes only, and are not intended to limit the scope of the invention in any way.

### Example 1

The yield value of various fat compositions for use in meat analogue compositions of the invention was calculated and compared to the yield value of coconut oil, RBD palm oil and rapeseed oil.

The methodology used to calculate the yield value was as described in A. J. Haighton, 1959, The measurement of the Hardness of Margarine and Fats with Cone Penetrometers, The Journal of the American Oil Chemists' Society, Vol 36, pages 345-349. The penetrometer analysis was done with the AOCS Cc 16_60 methodology, with a probe angle of 45°. The yield value (“C”) was measured using the formula indicated in the Haighton article and shown below.

C=KW/pⁿ
where C=yield value in g/cm²; W=weight of cone and all parts belonging to it (=total cone weight in g); n=1.6 (for margarine, butter and shortenings); p=penetration depth in 0.1 mm; and K=factor dependent on the cone angle.

The results of the yield analysis are shown in Table 1 below.

TABLE 1

| | | | | | Yield |
|---|---|---|---|---|---|
| | | W | P | | value C |
| Sample | Temperature | (g) | (mm) | K | (g/cm²) |
| Invention | 20 °C | 10 | 23.27 | 4700 | 306 |
| composition 1 | | | | | |
| Invention | 20 °C | 10 | 26.48 | 4700 | 249 |
| composition 2 | | | | | |
| Invention | 20 °C | 10 | 32.15 | 4700 | 182 |
| composition 3 | | | | | |
| Invention | 20 °C | 10 | 35.04 | 4700 | 159 |
| composition 4 | | | | | |
| Invention | 20 °C | 10 | 45.79 | 4700 | 103 |
| composition 5 | | | | | |
| Invention | 20 °C | 10 | 51.64 | 4700 | 85 |
| composition 6 | | | | | |
| Invention | 20 °C | 10 | 43.48 | 4700 | 112 |
| composition 7 | | | | | |
| Coconut oil | 20 °C | 10 | 8.50 | 4700 | 1531 |
| RBD palm oil | 20 °C | 10 | 1.43 | 4700 | 26648 |
| Rapeseed oil | 20 °C | 10 | 33.86 | 4700 | 168 |

Invention composition 1 was interesterified palm olein with an iodine number of 56.

Invention composition 2 comprised 80% by weight of interesterified palm olein with an iodine number of 56 and 20% by weight of palm olein with an iodine value of 62.

Invention composition 3 comprised 60% by weight of interesterified palm olein with an iodine number of 56 and 40% by weight of palm olein with an iodine value of 62.

Invention composition 4 comprised 50% by weight of interesterified palm olein with an iodine number of 56 and 50% by weight of palm olein with an iodine value of 62.

Invention composition 5 comprised 40% by weight of interesterified palm olein with an iodine number of 56 and 60% by weight of palm olein with an iodine value of 62.

Invention composition 6 comprised 20% by weight of interesterified palm olein with an iodine number of 56 and 80% by weight of palm olein with an iodine value of 62.

Invention composition 7 comprised 50% by weight of palm oil and 50% by weight of palm olein with an iodine value of 62.

The data in Table 1 shows that the fat compositions for use in the invention have yield values that are comparative to rapeseed oil. As such, these fat compositions are as easy to mix and process with the other ingredients of meat analogue compositions as liquid oils such as rapeseed oil. In contrast, it can be seen that both palm oil and coconut oil have far higher yield values meaning that these oils are far harder to mix and process with other ingredients of meat analogue compositions.

### Example 2

The fat compositions for use in the invention tested in Example 1 were tested for their crystallization induction time along with RBD palm oil, sunflower oil, and coconut oil.

The compositions for use in the invention have a high crystallization speed, as shown by the fast induction times (measured in a Crystallization Isotherm Analysis). The induction times are faster than coconut oil and comparative to palm oil. The crystallization isotherm is a set of Solid Fat Content analyses (measured using the IUPAC 2.150A as a reference), measured over time, at a constant temperature.

In this analysis, for each tested fat, 2 ml of a completely melted sample was transferred to a glass tube. The tubes with samples were kept at 60° C. for 30 min. Then, the solid fat content was measured in NRM equipment as time zero. Following, the sample was transferred immediately to a 5° C. cooling bath and a timer was started. In the minute one, the solid fat content was measured, and the sample placed back in the cooling bath. This procedure was repeated at every minute for 15 minutes. The Induction Time was defined when the SFC % measured was not higher than 4% from the last minute analysis.

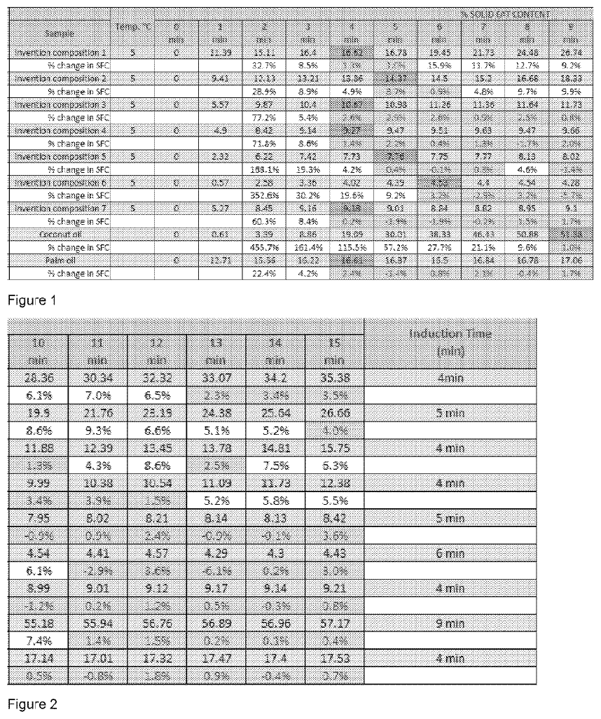

The tables depicted in FIGS. 1 and 2 show the solid fat content percentage isotherms for each fat composition discussed above in Example 1, coconut oil and palm oil. It can be seen that the fat compositions of the invention all had induction times comparative to palm oil and faster than coconut oil. This is indicative that the compositions of the invention will crystallize as fast as palm oil and faster than coconut oil when meat analogue compositions comprising said fat compositions are cooled down from room temperature to around −1° C. for further processing into burgers and other meat analogue food products.

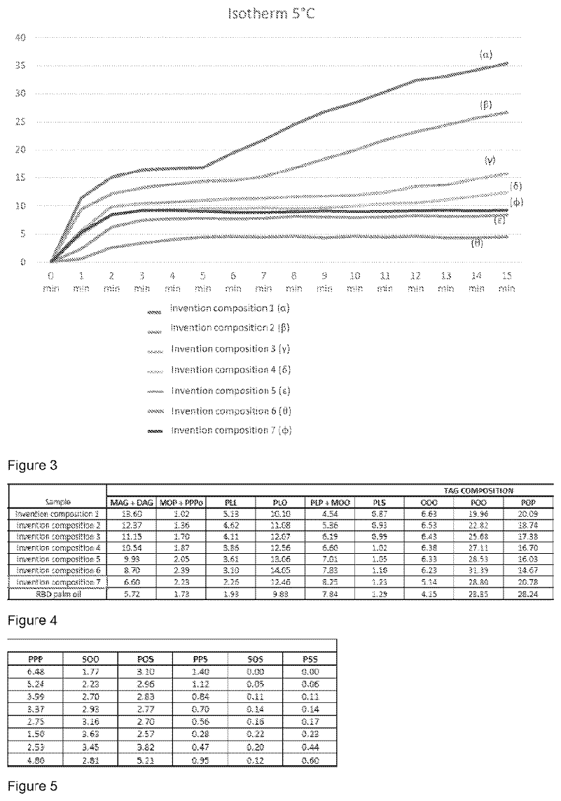

The faster fat crystallization during this step will mean that said meat analogue compositions have a higher solid fat content after the cooling step and there will be less problems with processing the meat analogue compositions than compositions comprising more liquid oils. The fast crystallization times equal to or faster than coconut oil and palm oil also indicates that the fat compositions will provide similar sensory and structuring properties when included in meat analogue compositions as palm oil and coconut oil. The isotherm discussed above for Invention compositions 1 to 7 is shown in FIG. 3. Example 3

The triacylglyceride (TAG) compositions of the Invention compositions 1 to 7 discussed above in Examples 1 and 2 are depicted in the tables in FIGS. 4 and 5.

In FIGS. 4 and 5, the following abbreviations are used.

MAG+DAG=Total amount of monoacylglycerides and diacylcylderides present in the composition.

For the other triglycerides indicated:
M=myristic acid
P=palmitic acid
O=oleic acid
Po=palmitoleic acid
S=stearic acid
L=linoleic acid

The values given in the tables in FIGS. 4 and 5 correspond to the weight percentage of each component by weight of glycerides present in the composition, as determined by a modified version of the method prescribed in Official Method Ce 5b-89 of the American Oil Chemists' Society (AOCS).

The modifications to the Ce 5B-89 method were as follows:
1. The HPLC mobile phase in the Ce 5b-89 method comprises a 50:50 mixture of acetonitrile and acetone. In the modified method, a mixture of acetonitrile and methyl tert-butyl ether (MTBE) was used. The volume ratio of MTBE to acetone was 33:67.
2. The Ce 5b-89 method specifies the use of a solubilization solvent containing acetone and chloroform present in a 1:1 ratio. In the modified method, a 1:1 volume ratio mixture of acetone and tetrahydrofuran was used.
3. The Ce 5b-89 method specifies the use of a 250 mm length column. In the modified method, 3 separate columns were used, with a combined length of 250 mm.
4. The Ce 5b-89 method specifies that a column temperature of 20° C. should be used, and the temperature maintained with a thermostated column oven. In the modified method, an oven temperature of 35° C. was used.
5. In the modified method, a lower HPLC column flow rate is used compared to the Ce 5b-89 official method. In the Ce 5b-89 method, just one HPLC column is used with a 1.5 mL/min flow rate. In the modified method, three HPLC columns are used in series and a flow rate of 0.8 mL/min is used.

### Example 4

A meat analogue composition of the invention was prepared that comprised a fat comprising Invention composition 4 from Example 1. The meat analogue composition was processed into a burger. A comparative meat analogue composition comprising coconut oil was also prepared. The burgers were then cooked.

The cooked burgers were tested for oil loss percentage and moisture loss percentage upon cooking using a one-way analysis of variance (ANOVA) test. The results are shown in the table below with grouping information using the Tukey method and 95% confidence. The

Moisture loss percentage

| Sample | N | Mean | Grouping |
|---|---|---|---|
| Meat analogue | 2 | 18.490 | A |
| composition of | | | |
| the invention | | | |
| Coconut oil | 2 | 16.630 | A |

Oil loss percentage

| Sample | N | | Grouping |
|---|---|---|---|
| Meat analogue | 2 | 7.275 | A |
| composition of | | | |
| the invention | | | |
| Coconut oil | 2 | 5.570 | A |

The same grouping letter A for the compositions indicates that there is no significant difference in oil loss or moisture loss upon cooking for the burger comprising coconut oil and the burger of the invention. This indicates that both burgers have comparative sensory properties for the consumer when cooked and consumed.

The tests were carried out by determining the following parameters and then making the following calculations.
Unbaked patty weight: (g)
Before preparing: (frying pan+oil) weight (g)
Cooked patty weight (g)
After preparing: (frying pan+oil) weight (g)

Then, make the calculations:
Weight loss=(Unbaked patty weight)−(Cooked patty weight)
Oil loss=(After (frying pan+oil) weight−Before (frying pan+oil) weight)
Moisture loss=(Weight loss)−(Oil loss)

The burgers were then subjected to a juiciness by aeropress test, using the following method.
After frying, remove the burger from the pan and allow to cool at room temperature (25±2° C.) for 5 min;
The sample weight is documented;
Document weight of the dish (e.g. cup) and Aeropress is positioned on the dish;
The sample is chopped into 49 pieces via 6 parallel and 6 perpendicular cuts;
Chopped samples are placed in the Aeropress (use it without filter paper) and compressed using a force/weight of 7 kg for 5 min;
Weight of extracted juice is recorded. Juice per cooked mass (JCM) is calculated;
Extracted juice is decanted in a test tube with scale on 0.1 ml and stored at a temperature over the fat melting point until the next day−chamber at 40° C.;
Right after the chamber, the tubes are stored at refrigerator at least for 2 hours, to allow a better visualization of separation;
A photo is taken for documentation.

The juice per cooked mass (JCM) can then be calculated by the formula JCM=Weight of extracted juice/weight of fried sample.

The results of the juiciness test are given in the tables below.

Meat analogue composition of the invention

| | Sample A | Sample B | Average |
|---|---|---|---|
| Sample weight | 81.94 | 82.51 | |
| after frying (g) | | | |
| Dish weight (g) | 46.09 | 46.50 | |
| Dish + Juice | 48.61 | 49.13 | |
| weight (g) | | | |
| Juice | 2.52 | 2.63 | |
| extracted (g) | | | |
| % Juice | 3.08 | 3.19 | 3.13% |
| cooked mass | | | |
| Volume water | 0.2 | 0.3 | |
| phase (ml) | | | |
| Volume oil | 2.3 | 2.3 | |
| phase (ml) | | | |

Meat analogue composition comprising coconut oil

| | Sample A | Sample B | Average |
|---|---|---|---|
| Sample weight | 85.16 | 84.24 | |
| after frying (g) | | | |
| Dish weight (g) | 46.53 | 46.42 | |
| Dish + juice | 48.87 | 48.85 | |
| weight (g) | | | |
| Juice | 2.34 | 2.43 | |
| extracted (g) | | | |
| % Juice | 2.75 | 2.88 | 2.82% |
| cooked mass | | | |
| Volume water | 0.1 | 0.1 | |
| phase (ml) | | | |
| Volume oil | 2.2 | 2.3 | |
| phase (ml) | | | |

The percentage juice per cooked mass produced from the cooked burgers was comparative for the meat analogue composition of the invention and the comparative meat analogue composition comprising coconut oil. This is indicative of the cooked burgers having comparative sensory properties when cooked.

The results of Example 3 thus show that meat analogue compositions of the invention have associated therewith sensory properties comparative to those known in the art comprising coconut oil.

1. A meat analogue composition comprising from 2% to 23% by weight of a fat composition; from 5% to 30% by weight of a non-animal protein; and from 30% to 70% by weight of water; wherein the fat composition comprises from 10% to 40% by weight of palmitic acid (C16:0); from 1% to 15% by weight of stearic acid (C18:0); and from 35% to 70% by weight of oleic acid (C18:1); wherein said percentages of fatty acid residues refers to fatty acids bound as acyl groups in glycerides in the fat composition and being based on the total weight of C4 to C24 fatty acid residues bound as acyl groups present in the fat composition; and wherein the fat composition (i) has a saturated fatty acid content of from 25% to 50% by weight; (ii) comprises greater than 1.5% by weight of S₃ triglycerides, wherein S refers to a saturated C14 to C20 fatty acid moiety present in the triglyceride molecule; and (iii) comprises less than 34% by weight of SUS triglycerides, wherein S refers to a saturated C14 to C20 fatty acid moiety and wherein U refers to a C14 to C20 unsaturated fatty acid moiety present in the triglyceride molecule; wherein said percentages of triglycerides refers to percentage by weight of glycerides present in the fat composition.

2. A meat analogue composition according to claim 1, wherein the fat composition comprises from 1.5% to 8% by weight of S₃ triglycerides.

3. (canceled)

4. A meat analogue composition according to claim 1, wherein the fat composition comprises from 18% to 34% by weight of SUS triglycerides.

5. A meat analogue composition according to claim 1, wherein the fat composition comprises a weight ratio of SUS triglycerides to SUU triglycerides of from 0.35 to 0.90.

6. (canceled)

7. A meat analogue composition according to claim 1, wherein the fat composition comprises the triglycerides POP, PPP, OOO and SOS in a total amount of from 22% to 34% by weight.

8. (canceled)

9. A meat analogue composition according to claim 1, wherein the fat composition comprises the triglyceride PPP in an amount greater than 1% by weight.

10. (canceled)

11. A meat analogue composition according to claim 1, wherein the fat composition comprises the triglyceride POP in an amount less than 25% by weight.

12. A meat analogue composition according to claim 1, wherein the fat composition comprises the triglycerides PLP and MOO in a combined amount of 8% or less by weight.

13. A meat analogue composition according to claim 1, wherein the fat composition comprises the triglyceride POO in an amount of from 15% to 35%; the triglyceride OOO in an amount of from 2% to 10%; and/or the triglyceride PLO in an amount of from 7.5% to 17.5%.

14. A meat analogue composition according to claim 1, wherein the fat composition comprises any one or more of:
(a) from 1% to 3% of a combined amount of the triglycerides MOP and PPP;
(b) from 2% to 6% of the triglyceride PLL;
(c) from 0.5% to 2% of the triglyceride PLS;
(d) less than 5% of the triglyceride SOO;
(e) less than 5% of the triglyceride POS;
(f) less than 5% of the triglyceride PPS;
(g) less than 1% of the triglyceride SOS; and
(h) less than 1% of the triglyceride PSS.

15. A meat analogue composition according to claim 1, wherein the fat composition comprises from 4% to 15% by weight linoleic acid (C18:2) linoleic acid.

16. A meat analogue composition according to claim 1, wherein the fat composition comprises one or more of the following features:
(i) from 20% to 40% by weight palmitic acid (C16:0);
(ii) from 2% to 11% by weight stearic acid (C18:0);
(iii) from 38% to 58% by weight oleic acid (C18:1); and
(iv) from 7% to 15% by weight linoleic acid (C18:2).

17. A meat analogue composition according to claim 1, wherein the fat composition has a saturated fatty acid content of from 33% to 48% by weight.

18. A meat analogue composition according to claim 1, wherein the fat composition (i) has a monounsaturated fatty acid content of from 35% to 70% by weight; and/or (ii) has a polyunsaturated fatty acid content of from 4% to 15% by weight.

19. A meat analogue composition according to claim 1, wherein the fat composition has one or more of the following features:
(i) a solid fat content at 10° C. of from 16 to 55;
(ii) a solid fat content at 20° C. of from 6 to 33;
(iii) a solid fat content at 25° C. of from 1 to 24; and
(iv) a solid fat content at 30° C. of at most 17.

20. A meat analogue composition according to claim 19, wherein the fat composition comprises all of features (i) to (iv).

21. A meat analogue composition according to claim 1, wherein the fat composition comprises (i) an interesterified palm olein with an iodine number of from 54 to 58; (ii) a blend of an interesterified palm olein with an iodine number of from 54 to 58 and a palm olein with an iodine number of from 60 to 64; or (iii) a blend of a palm olein with an iodine number of from 60 to 64 and palm oil.

22. (canceled)

23. A meat analogue composition according to claim 21, wherein (a) the interesterified palm olein with an iodine number of from 54 to 58 is interesterified palm olein with an iodine number of 56; and/or (b) the palm olein with an iodine number of from 60 to 64 is palm olein with an iodine number of 62.

24. A meat analogue composition according to claim 1, wherein the nonanimal protein comprises protein derived from fungi, plants, or a combination thereof.

25. (canceled)

26. (canceled)

27. (canceled)

28. (canceled)

29. A meat analogue composition according to claim 1, wherein the meat analogue composition comprises a stabilizer blend.

30. (canceled)

31. (canceled)

32. (canceled)

33. (canceled)

34. (canceled)

35. (canceled)

36. A meat analogue composition according to claim 1, wherein the fat composition is present in the meat analogue composition in an amount of from 7.5% to 23% by weight of the meat analogue composition.

37. A meat analogue composition according to claim 1, wherein the nonanimal protein is present in the meat analogue composition in an amount of from 10% to 30% by weight of the meat analogue composition.

38. A meat analogue composition according to claim 1, wherein the meat analogue composition is substantially free of animal protein.

39. A meat analogue composition according to claim 1, wherein the meat analogue composition is substantially free of animal-derived products.

40. A meat analogue composition according to claim 1, wherein the meat analogue composition further comprises one or more animal-derived products such as animal oils, marine oils, animal-derived proteins, animal-derived polysaccharides, or any combination thereof.

41. (canceled)

42. (canceled)

43. A food product comprising a meat analogue composition according to claim 1.

44. A food product according to claim 43, wherein the food product is an uncooked food product, a cooked food product, or a partially cooked food product.

45. A food product according to claim 43, wherein the food product is a vegetarian or vegan meat substitute food product.

46. (canceled)

47. (canceled)

48. (canceled)

49. (canceled)

50. (canceled)

51. (canceled)

52. (canceled)

53. A process of manufacturing a meat analogue composition according to claim 1, wherein the process comprises:
(a) providing a mixture of water and non-animal protein;
(b) combining the mixture from step (a) with the fat composition and optionally one or more additional components to form the meat analogue composition; and
(c) optionally forming the meat analogue composition into food products.

54. A process according to claim 53, wherein the process further comprises cooking the food product to form a cooked food product or partially cooked food product.

55. A process according to claim 53, wherein the process further comprises mixing (i) the mixture of water and non-animal protein provided in step (a); (ii) a mixture formed in step (b) by combining the mixture from step (a) with the fat composition and optionally one or more additional components; and/or (iii) mixing the one or more additional components with water prior to combination of the one or more additional components with the mixture from step (a) and fat composition.

56. A process according to claim 53, wherein the fat composition is not melted prior to combining with the mixture from step (a) and optionally one or more additional components.

57. A process according to claim 56, wherein the process comprises mixing a mixture formed in step (b) by combining the mixture from step (a) with the fat composition and optionally one or more additional components.

58. (canceled)

59. A process according to claim 53, wherein the process comprises step (c) of forming the meat analogue composition into food products, and wherein after step (b) but prior to step (c), the process further comprises cooling the meat analogue composition to a temperature of from −5° C. to 5° C.; preferably from −2° C. to 2° C.

60. (canceled)
